(19) United States
(12) Patent Application Publication
(10) Pub. No.: US 2022/0321641 A1
(43) Pub. Date: Oct. 6, 2022

(54) Distributed Deep Learning System

(71) Applicant: Nippon Telegraph and Telephone Corporation, Tokyo (JP)

(72) Inventors: Tsuyoshi Ito, Tokyo (JP); Kenji Kawai, Tokyo (JP); Junichi Kato, Tokyo (JP); Huycu Ngo, Tokyo (JP); Yuki Arikawa, Tokyo (JP); Takeshi Sakamoto, Tokyo (JP); Kenji Tanaka, Tokyo (JP)

(21) Appl. No.: 17/627,346

(22) PCT Filed: Jul. 16, 2019
(86) PCT No.: PCT/JP2019/027922

§ 371 Date: Jan. 14, 2022

(51) Int. Cl. H04L 67/10; H04L 67/2866; G06N 3/08

(52) U.S. Cl. CPC H04L 67/10; H04L 67/2866; G06N 3/08

(57) ABSTRACT

A distributed deep learning system according to an embodiment includes M distributed processing nodes that perform deep learning of a neural network distributed from each other, and N aggregation processing nodes that are connected to each of the M distributed processing nodes via a first communication line and a second communication line, and perform aggregation of distributed processing results obtained at the M distributed processing nodes via the first communication line. Accordingly, even in a case of a plurality of users sharing the distributed deep learning system at the same time, efficient and stable distributed deep learning processing can be realized.

### CROSS-REFERENCE TO RELATED APPLICATION

This application is a national phase entry of PCT Application No. PCT/JP2019/027922, filed on Jul. 16, 2019, which application is hereby incorporated herein by reference.

### TECHNICAL FIELD

The present invention relates to distributed deep learning technology that performs deep learning of a neural network by cooperation between an aggregation processing node and a plurality of distributed processing nodes.

### BACKGROUND

In recent years, artificial intelligence (AI) is being used as a system for computers to mechanically learn things and rules. One specific learning technique thereof is a machine learning technique by multilayer neural network (Deep Neural Network (DNN)), i.e., deep learning. In deep learning, inference precision is improved regarding a learning target made up of a multilayer neuron model, by updating weighting (a coefficient by which a value output from an upstream neuron model is multiplied) of each neuron model on the basis of input sample data.

As a learning technique of improving inference precision, there is the minibatch method (mini-batch learning), which is a type of gradient descent. In the mini-batch method, first, preprocessing where optional data of a minibatch size is extracted from a great number of pieces of sample data and processing of data processing is performed, gradient calculation processing where a gradient is calculated for the aforementioned weight for each piece of sample data subjected to preprocessing, aggregation processing where the gradient obtained for each piece of sample data is combined for each weight, and weight updating processing where the weights are updated on the basis of the aggregated gradients, are repeated.

Out of these types of processing, gradient calculation processing requires a great number of times of computation, but increasing the count of weights and the count of pieces of sample data input, in order to improve inference precision, increases the amount of time required for deep learning, and accordingly, the technique of distributed processing is used. A specific configuration of such distributed processing has a plurality of processing nodes provided, with an interconnect connecting between each of the processing nodes (see NPL 1, etc., for example). In this system, the processing nodes each perform gradient calculation processing with regard to different sample data. Accordingly, the count of pieces of sample data that can be processed per unit time can be increased proportionately to the number of processing nodes, and thus the speed of gradient calculation processing can be increased.

### CITATION LIST

### Non-Patent Literature

[NPL 1] Takuya Akiba, “Bunsan Shinsou Gakusyuu Pakkeji Chainer MN Koukai (Distributed Deep Learning Package Chainer MN Release)”, Preferred Infrastructure, 2017 May 9, Internet https://research.preferred.jp/2017/05/chainermn-beta-release/

[NPL 2] “baidu-research/baidu-allreduce”, 24 Feb. 2017, Internet <https://github.com/baidu-research/baidu-allreduce>

### SUMMARY

### Technical Problem

FIG. 6 is a block diagram illustrating a configuration example of a conventional distributed deep learning system. FIG. 6 illustrates a conventional configuration example regarding a distributed deep learning system 500 that performs distributed processing of deep learning.

The conventional distributed deep learning system 500 illustrated in FIG. 6 is provided with one aggregation processing node 501a and an Na count (where Na is an integer of 1 or greater) of distributed processing nodes 502a (#1, #2, . . . , *Na) provided for each set of sample data (e.g., learning data) used for deep learning of a user A, and one aggregation processing node 501b provided to a user B and an Nb count (where Nb is an integer of 1 or greater) of distributed processing nodes 502b (#1, #2, . . . , #Nb) provided for each set of sample data (e.g., learning data) used for deep learning of the user B.

Also, in the conventional distributed deep learning system 500, the distributed processing nodes 502a and 502b are connected in a ring form with the aggregation processing nodes 501a and 501b by an interconnect 503 that is capable of bidirectional communication. That is to say, in the conventional distributed deep learning system 500, a plurality of pairs of one aggregation processing node 501 and an N count (where N is an integer of 1 or greater) of distributed processing nodes 502 (#1, #2, . . . , #N) is provided for each user, connected in a ring form by the interconnect 503.

In a case of performing deep learning in the conventional distributed deep learning system 500, users operate console terminals 504a and 504b connected to the aggregation processing nodes 501a and 501b and instruct execution commands for deep learning from the console terminals 504a and 504b. The aggregation processing nodes 501a and 501b have, in advance, datasets including minibatch data for distributed deep learning, and distribution and control of minibatch data to the distributed processing nodes 502a and 502b that form pairs with the aggregation processing nodes 501a and 501b are distributed in-band via the interconnect 503.

In order to perform aggregation processing at the aggregation processing nodes 501a and 501b, aggregation communication that is communication from the distributed processing nodes 502a and 502b to the aggregation processing nodes 501a and 501b is required, in order to perform aggregation of the distributed processing results obtained from each of the distributed processing nodes 502a and 502b at the aggregation processing nodes 501a and 501b. Also, distribution communication that is communication from the aggregation processing nodes 501a and 501b, to the distributed processing nodes 502a and 502b is necessary to transfer the aggregation processing results aggregated at the aggregation processing nodes 501a and 501b to the distributed processing nodes 502a and 502b, in addition to all-processing-node aggregation processing at the aggregation processing nodes 501a and 501b.

Generally, in the distributed deep learning system 500, the gradient calculation processing, aggregation processing, and updating processing, in the above-described minibatch method, are performed by processing called “Ring AllReduce”, in detail (see NPL 2, etc., for example). Conversely, preprocessing in the minibatch method is often processed at independent processing nodes such as the aggregation processing nodes 501a and 501b, for example. Preprocessing data obtained in preprocessing, such as datasets including minibatch data for distributed deep learning, model data including initial values of gradient data relating to a learning model used in deep learning and parameters for identifying the learning model, and so forth, are distributed in-band via the interconnect 503 from the aggregation processing nodes 501a and 501b to the distributed processing nodes 502a and 502b.

In recent years, increasingly large scales of distributed deep learning systems has led to a plurality of sets of learning processing being carried out at the same time, such as a plurality of users sharing a distributed deep learning system, and preprocessing of sample data is performed for each such learning processing. Accordingly, there is an upward trend in occurrence of standby time regarding communication necessary for distributed deep learning, such as aggregation communication and distributed communication. Also, the increase in preprocessing is increasing the in-band data processing load at the aggregation processing nodes 501 that are the main entity of preprocessing and the distributed processing nodes 502 receiving the preprocessing data. In this way, there has been a problem in a case of a plurality of users sharing and using a distributed deep learning system, in that increase in the data processing load accompanying preprocessing reduces the efficiency of high-speed deep learning.

The present invention has been made taking the foregoing into consideration, and it is an object thereof to provide a distributed deep learning technology that can realize efficient and stable distributed deep learning processing even in a case where a plurality of users share a distributed deep learning system at the same time.

### Means for Solving the Problem

In order to achieve this object, the distributed deep learning system according to an embodiment of the present invention includes an M count (where M is an integer of 2 or greater) of distributed processing nodes that perform deep learning of a neural network distributed from each other, and an N count (where N is an integer no greater than M) of aggregation processing nodes that are connected to each of the M distributed processing nodes via a first communication line and a second communication line, and perform aggregation of distributed processing results obtained at the M distributed processing nodes via the first communication line.

### Effects of Embodiments of the Invention

According to the present invention, in distributed learning processing, execution of deep learning at aggregation processing nodes and distributed processing nodes can be controlled from an execution node via a second communication line independent from a first communication line, without affecting distributed processing data exchanged among the aggregation processing nodes and the distributed processing nodes via the first communication line. Accordingly, reduction on learning efficient in neural networks and increase in processing load on processing nodes can be suppressed as compared to a conventional distributed deep learning system, even in a case of a plurality of users sharing the distributed deep learning system at the same time, and as a result, efficient and stable distributed deep learning processing can be realized.

### BRIEF DESCRIPTION OF THE DRAWINGS

FIG. 1 is a block diagram illustrating a configuration example of a distributed deep learning system according to a first embodiment.

FIG. 2 is a block diagram illustrating a configuration of a processing node.

FIG. 3 is a block diagram illustrating a configuration of an execution node.

FIG. 4 is a graph illustrating change in learning time per epoch as to communication bandwidth.

FIG. 5 is a block diagram illustrating a configuration example of a distributed deep learning system according to a second embodiment.

FIG. 6 is a block diagram illustrating a configuration example of a conventional distributed deep learning system.

### DETAILED DESCRIPTION OF ILLUSTRATIVE EMBODIMENTS

Next, embodiments of the present invention will be described with reference to the figures.

### First Embodiment

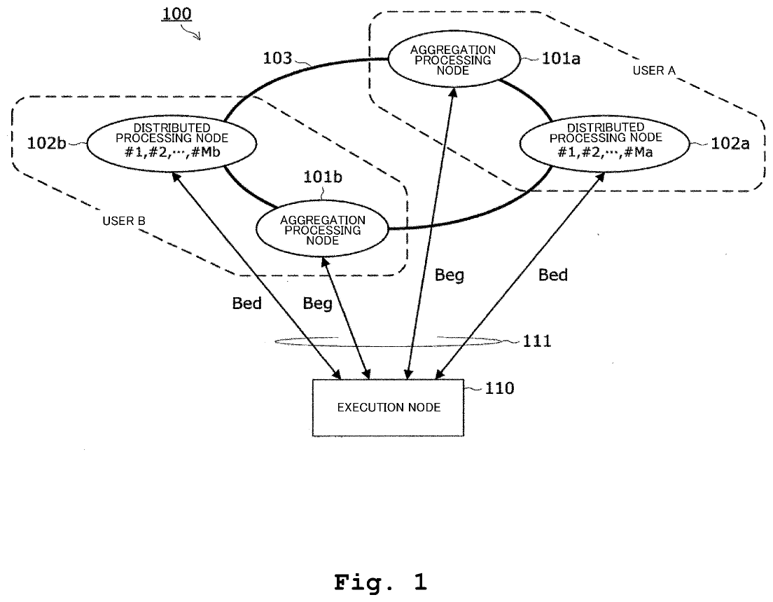

First, a distributed deep learning system 100 according to a first embodiment of the present invention will be described with reference to FIG. 1. FIG. 1 is a block diagram illustrating a configuration example of the distributed deep learning system according to the first embodiment.

### Distributed Deep Learning System

As illustrated in FIG. 1, the distributed deep learning system 100 according to the present embodiment is provided with one aggregation processing node 101a provided to a user A and Ma (where Ma is an integer of 1 or greater) distributed processing nodes 102a (#1, #2, . . . , #Ma) provided for each set of sample data (learning data) used for deep learning of the user A, and one aggregation processing node 101b provided to a user B and Mb (where Mb is an integer of 1 or greater) distributed processing nodes 102b (#1, #2, . . . , #Mb) provided for each set of sample data (learning data) used for deep learning of the user B.

### Aggregation Processing Nodes and Distributed Processing Nodes

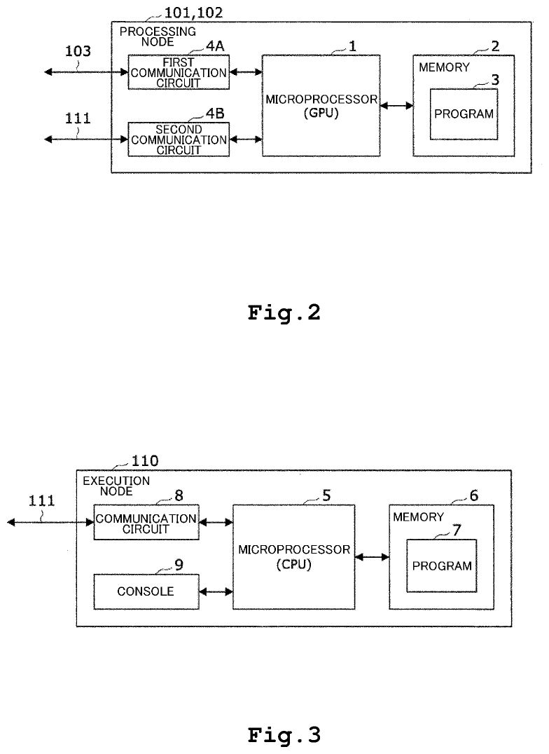

The aggregation processing nodes 101a and 101b (collectively, aggregation processing nodes 101) and the distributed processing nodes 102a and 102b (collectively, distributed processing nodes 102) are as a whole made up of computation processing devices (e.g., computers) such as server devices or the like. FIG. 2 is a block diagram illustrating a configuration of a processing node. As illustrated in FIG. 2, the processing node that is an aggregation processing node 101 and a distributed processing node 102 executes various types of processing relating to deep learning, by collaboration between a microprocessor 1 and a program 3 stored in memory 2. The program 3 is stored in the memory 2 in advance, from an external device or a recording medium.

Each of the aggregation processing node 101 and the distributed processing node 102 has a GPU (Graphics Processing Unit) that handles computation processing for learning installed therein, as a microprocessor. A specific example of a GPU is “P100” manufactured by NVIDIA (registered trademark) Corporation. Note that in some embodiments of the present invention, “processing node” means equipment such as a server device or the like that is arranged distributed on a network.

The distributed processing nodes 102 are connected in a ring form with the aggregation processing node 101 by an interconnect 103 capable of bidirectional communication. The interconnect 103 is connected to a first communication circuit 4A in FIG. 2, in the aggregation processing node 101 and the distributed processing node 102. Hereinafter, the interconnect 103 may also be referred to simply as a ring 103.

### Interconnect (Ring)

The interconnect 103 combines a network card having a communication speed of 100 [Gbps] (Giga bits per second) for example, and a QSFP28-SR4 (Quad Small Form-factor Pluggable) optical transceiver installed in the aggregation processing node 101 and the distributed processing node 102 as the first communication circuit 4A, with a multicore optical fiber for SR4 that is provided with an MPI (Metallized Particle Interconnect) connector, thereby forming a communication path with a communication speed of 100 [Gbps]. A specific example of a network card is “VCU118” by Xilinx, Inc. (registered trademark) that is made up of an FPGA card in which is implemented a processing circuit specialized for aggregation communication and distributed communication, for example.

Description will be made below assuming a case of two users, A and B, using the distributed deep learning system 100 at the same time. Specifically, assumption will be made that the user A performs deep learning using the aggregation processing node 101a and the distributed processing node 102a, and the user B performs deep learning using the aggregation processing node 101b and the distributed processing node 102b. In order to facilitate understanding, FIG. 1 illustrates a configuration of the distributed deep learning system 100 in which the number of users is two, and in which the number of distributed processing nodes is one for each user, i.e., in which the number of processing nodes of the overall system is four. Note that correlation between the M aggregation processing nodes 101 and the N distributed processing nodes 102 is not fixed, and is flexibly updated on-the-fly, in accordance with parameters such as the number of weights, the number of pieces of sample data input, and so forth.

Generally, distributed deep learning systems with these nodes connected in a ring form may also be referred to as ring distributed deep learning systems. Note that although a connection configuration in which the nodes are connected in a ring form is described in the present embodiment as an example, this is not limiting, and the present invention as follows can be equally applied to distributed deep learning systems that have star-type or other connection configurations.

### Execution Node and Communication Line

The generalized distributed deep learning system 100 according to an embodiment of the present invention has a configuration in which a plurality of pairs of one aggregation processing node 101 and M (where M is an integer of 1 or greater) distributed processing nodes 102 (#1, #2, . . . , #M) is provided. In the configuration example in FIG. 1, two pairs are provided respectively to the users A and B. The distributed deep learning system 100 according to an embodiment of the present invention has an execution node 110 individually connected to these nodes in a tree form, via a communication line 111.

The execution node 110 is overall made up of a computation processing device (computer) such as a personal computer, a server device, or the like, and executes various types of processing relating to deep learning, by collaboration between a microprocessor 5 and a program 7 stored in memory 6. FIG. 3 is a block diagram illustrating a configuration of an execution node.

The execution node 110 has a CPU installed as the microprocessor 5, and controls the aggregation processing nodes 101 and the distributed processing nodes 102 in accordance with operations made by a user or an operator, that are detected by a console 9 in FIG. 3. The execution node 110 also displays various types of screens, such as a settings screen, a control screen, a results screen, and so forth, on the console 9.

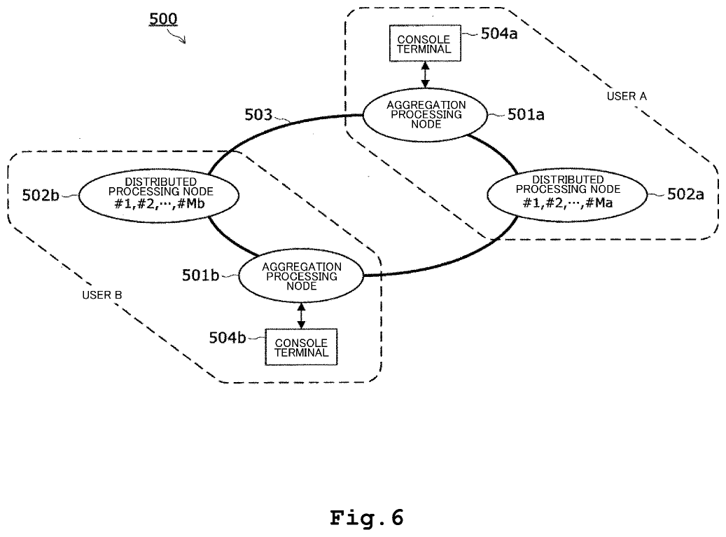

In a case of performing deep learning with the above-described conventional distributed deep learning system 500 illustrated in FIG. 6, the users operate console terminals 504a and 504b connected to the aggregation processing nodes 501a and 501b, thereby instructing execution commands for deep learning from the console terminals 504a and 504b. The aggregation processing nodes 501a and 501b have datasets for learning in advance, and distribution and control of minibatch data from the aggregation processing nodes 501a and 501b to the distributed processing nodes 502a and 502b is distributed in-band via the interconnect 503 that configures a ring.

In embodiments of the present invention, the individual execution node 110 is provided that is different from the aggregation processing nodes 101 and the distributed processing nodes 102 making up the distributed deep learning system 100, as illustrated in FIG. 1, instead of such console terminals 504a and 504b. In this configuration, the execution node 110 is individually connected to the aggregation processing nodes 101 and the distributed processing nodes 102 by the communication line 111 in a tree form. The execution node 110 is provided with a plurality of network cards or network ports as the communication circuit 8 in FIG. 3. The communication line 111 is connected to a second communication circuit 4B in FIG. 2 at the aggregation processing nodes 101 and the distributed processing nodes 102.

Even in a case where a communication shutdown occurs on part of the ring 103, the communication between the execution node 110 and the aggregation processing nodes 101 and distributed processing nodes 102 by this communication line 111 is maintained. Accordingly, control is enabled such as performing changing control of detour settings of the ring 103 and so forth, triggered by a communication shutdown occurring on part of the ring 103, from the execution node 110. Thus, a high level of reliability can be guaranteed in the distributed deep learning system 100.

### System Operations

Next, operations of deep learning relating to the user A by the above-described minibatch method, using the one aggregation processing node 101a and the Ma distributed processing nodes 102a, will be described as operations of the distributed deep learning system 100 according to the present embodiment.

First, virtual login is performed from the execution node 110 to the aggregation processing node, and the aggregation processing node 101a executes preprocessing in accordance with operations by the user A or an operator. In this preprocessing, sample data prepared in advance is extracted and processing of data processing set in advance is performed for each deep learning to be executed distributed among the distributed processing nodes 102a, i.e., for each minibatch, thereby generating minibatch data. Next, the aggregation processing node 101a distributes the group of the minibatch data, i.e., a dataset, to the distributed processing nodes 102a via the communication line 111 and the execution node 110.

Also, the execution node 110 distributes model data such as initial values of gradient data relating to the learning model used in deep learning and parameters for identifying the learning model, and so forth, to the aggregation processing node 101a via the communication line 111, before or after the dataset. The execution node 110 also commands the aggregation processing node 101a and the distributed processing nodes 102a to execute deep learning, via the communication line 111.

The aggregation processing node 101a receives the dataset from the execution node 110 via the communication line 111, and distributes the minibatch data included in this dataset to each of the distributed processing node 102a via the interconnect 103, in accordance with the execution command for deep learning from the execution node 110 via the communication line 111. The aggregation processing node 101a also receives the model data from the execution node 110 via the communication line 111, and distributes the received model data to each of the distributed processing nodes 102a via the interconnect 103 in accordance with the execution command for deep learning from the execution node 110 via the communication line 111.

The distributed processing nodes 102a each receive the minibatch data and the model data from the aggregation processing node 101a via the interconnect 103, and execute deep learning processing in accordance with the execution command for deep learning from the execution node 110 via the communication line 111. Specifically, gradient calculation processing of calculating gradients relating to weights of the neuron models is executed, using minibatch data and model data.

The aggregation processing node 101a executes aggregation processing of receiving via the interconnect 103, and aggregating the distributed processing results calculated at each of the distributed processing nodes 102a, i.e., gradients. Thereafter, the aggregation processing node 101a executes updating processing in which the weights of the neuron models are updated in accordance with the obtained aggregation results, and distributes the updated weights to each of the distributed processing nodes 102a via the interconnect 103.

Thus, deep learning is repeatedly executed by exchanging learning processing data to be used for distributed deep learning between the aggregation processing node 101a and the distributed processing nodes 102a via the interconnect 103. Thereafter, at a point in time at which certain conditions are satisfied, the aggregation processing node 101a distributes the learning results, i.e., the weights of the neuron models, to the execution node 110 via the communication line 111, and ends the series of operations for deep learning.

### Evaluation of System

Evaluation of learning time necessary for deep learning was performed using the distributed deep learning system 100 in FIG. 1. In this evaluation, a learning model based on VGG16 was used as the learning model using general-use neural networks, and for general-use learning image data, a dataset called CIFER10 that contains ten types of images was used. The batch size was 100. VGG16 is a convolutional neural network (CNN) with 13 layers of convolutional layers and three layers of fully-connected layers for a total of 16 layers.

For evaluation, a personal computer having a network card with four LAN ports installed to a PCIe (Peripheral Component Interconnect Express) is prepared as the execution node 110 for the processing nodes (aggregation processing node 101 and distributed processing nodes 102), and connection thereof to the processing nodes in a tree form is performed via the communication line 111. Each processing node was given a different IP address under the same subnet, and the processing nodes were arranged to be able to be controlled from the execution node 110 via a SSH (Secure SHell) protocol. Also, settings to permit SSH connection among the processing nodes without password were made, to guarantee connectability among the processing nodes via the execution node 110.

In order to evaluate learning time necessary for deep learning, connection was made from the execution node 110 to the processing nodes and settings necessary for learning were performed, and learning processing commands were given to each of the aggregation processing node 101a of the user A and the aggregation processing node 101b of the user B. In the evaluation of learning time, the learning time in one epoch was evaluated with regard to the user A, and how the communication bandwidth and learning time changed was investigated.

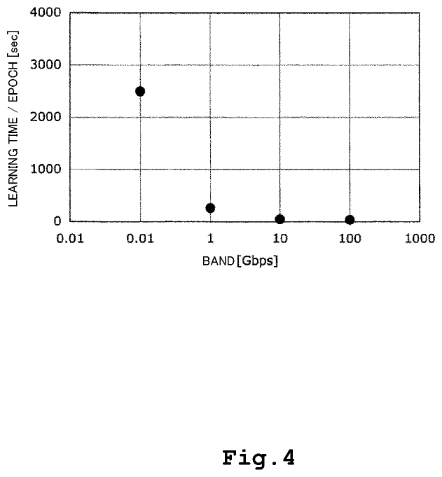

FIG. 4 is a graph illustrating change in learning time per one epoch as to communication bandwidth. Learning time required for deep learning per one epoch is plotted for each communication bandwidth of the communication path made up of the execution node 110 and the communication line 111 in FIG. 4. From this FIG. 4, it was found that learning time was reduced in a region in communication bandwidth from 10 [Mbps] (Mega bits per second) to around 10 [Gbps], and was generally saturated in a region of communication bandwidth of 100 [Gbps] and higher.

Further, with the communication bandwidth of the interconnect 103 as Bi, and the communication bandwidth between the execution node 110 and the processing nodes (aggregation processing nodes 101 and distributed processing nodes 102) as Be, it was found as a result of performing verification while changing parameters variously that in processing in which the load of distributed deep learning was expected to be great (e.g., processing in which the learning model or image data was large, etc.), deterioration in learning time could be suppressed in a case of a relation in which Be is greater than 1/100 of Bi, as in the following Expression (1).

Be>Bi×0.01 (1)

The performance of the distributed deep learning system 100 indicates that the processing capabilities of the GPU (up to several TFLOPS (Tera Floating-point Operations Per Second)) and the communication bandwidth of the interconnect 103 (up to several 100 [Gpbs]) used in the distributed deep learning are in a generally proportional relation. It can be said that in the future, in a case where there is marked increase in processing capabilities of the GPU, the communication bandwidth of the interconnect 103 will increase as well, and increase in the communication bandwidth between the execution node 110 according to embodiments of the present invention and the processing nodes 101 and 102 will also become necessary.

Note that in the above evaluation, there were cases in which processing of distributed deep learning stopped when the communication bandwidth Be between the execution node 110 and the processing nodes was narrower than the relation in Expression (1) (Be≤Bi×0.01), and a problem of instability occurred. This means that the communication bandwidth Bi of the interconnect 103 connecting among the processing nodes, and between the execution node 110 and the processing nodes is important, and it should be noted that the point of finding the relation relating to communication bandwidth such as in Expression (1) is an extremely important parameter constraint.

Also, in the present configuration, in a case of distributing datasets for learning from the aggregation processing node 101 to a plurality of distributed processing nodes 102 via the interconnect 103, datasets for learning are continuously distributed from the execution node 110 to the aggregation processing node 101 via the LAN line 111 in advance. Accordingly, the communication bandwidth between the execution node 110 and the aggregation processing node 101 is preferably broader than the communication bandwidth between a later-described network switch and the distributed processing nodes 102.

That is to say, the relation shown in the following Expression (2), in which a communication bandwidth Beg at the side connected to the aggregation processing node 101 is greater than a communication bandwidth Bed at the side connected to the distributed processing nodes 102, is necessary.

Beg>Bed (2)

Accordingly, data can be distributed to the distributed processing nodes 102 with low latency, and thus, in a case of the same user occupying continuous distributed processing nodes 102 on the ring 103, the distributed processing nodes 102 can start learning without delay after starting of learning with a dataset being commanded from the aggregation processing node 101, thereby enabling overall reduction in learning time.

Also, from analysis of a profiler monitoring the processing process, the capabilities of the communication path configured of the execution node 110 and the communication line 111 in this way are constrained primarily in cases of distributing minibatch data to the nodes and updating the learning model to the distributed processing nodes 102, in preprocessing. In contrast to distributed deep learning processing normally performed in-band, the learning carried out by the present configuration performs only aggregation communication and distribution communication for learning itself by the interconnect 103 (in-band), and distribution of data such as minibatches and distribution of initial parameters and so forth is not performed in-band but is configured to be performed out-band, which is a great feature of the present configuration. Having such a feature yields an advantage in that processing design of the overall learning necessary for efficient learning is facilitated.

### Advantages of First Embodiment

In this way, the present embodiment is an arrangement in which the distributed processing nodes 102 and the aggregation processing node 101 are each connected to the execution node 110 via a communication line 111 that is different from the interconnect 103, with the execution node 110 controlling execution of deep learning at the distributed processing nodes 102 and the aggregation processing node 101 via the communication line 111. More specifically, when commanding execution of deep learning, the execution node 110 distributes minibatch data extracted from sample data used for deep learning, and model data such as initial values of gradient data relating to a learning model used in deep learning and parameters for identifying the learning model, to the aggregation processing node 101 via the communication line 111.

Accordingly, in distributed learning processing, execution of deep learning at the aggregation processing node 101 and the distributed processing nodes 102 can be controlled from the execution node 110 via the communication line 111 separate from the interconnect 103, without affecting distributed processing data such as gradient and weights exchanged among the aggregation processing node 101 and the distributed processing nodes 102 via the interconnect 103. Also, preprocessing data such as datasets of minibatch data and model data necessary for distributed learning processing generated in preprocessing can be distributed from the execution node 110 to the aggregation processing node 101 via the individual communication line 111, without affecting the distributed processing data.

Accordingly, processing delay due to recalculation and so forth, from unstable operations such as processing stoppage and output of erroneous results, can be avoided in the distributed deep learning system 100. Accordingly, even in a case of a plurality of users sharing the distributed deep learning system 100 at the same time, reduction in learning efficiency of the neural networks and increased processing load at the processing nodes can be suppressed as compared to a conventional distributed deep learning system, and consequently, efficient and stable distributed deep learning processing can be realized.

Also, the role of the processing by the execution node 110 may be virtually handled by the processing nodes that are the aggregation processing node 101 and the distributed processing nodes 102 in the present embodiment. In this case, it is sufficient to connect among the processing nodes by the communication line 111 in a mesh form. At this time, the connection configuration is in a tree form (aggregation→distributed), but this changes depending on which processing node handles which of aggregation processing and distributed processing, and accordingly, flexible handling can be performed by connecting by the communication line 111 in a mesh form.

### Second Embodiment

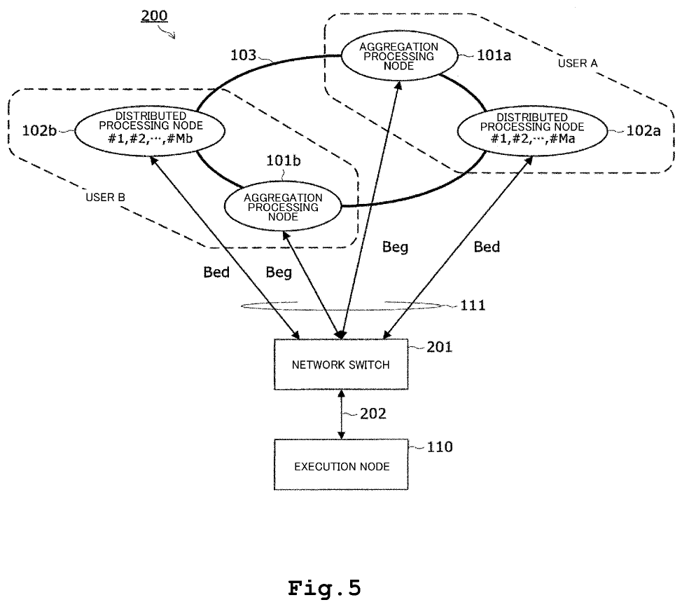

Next, a distributed deep learning system 200 according to a second embodiment of the present invention will be described with reference to FIG. 5. FIG. 5 is a block diagram illustrating a configuration example of the distributed deep learning system according to the second embodiment. Portions in FIG. 5 that are the same as or equivalent to those in FIG. 1 are denoted by the same signs.

The distributed deep learning system 200 illustrated in FIG. 5 differs from that described above in FIG. 1 with regard to the point that a network switch 201 is added between the execution node 110 and the communication line 111. That is to say, the execution node 110 is connected to the network switch 201 via a communication line 202, and the network switch 201 is connected to each of the aggregation processing nodes 101a and 101b (collectively, aggregation processing nodes 101) and the distributed processing nodes 102a and 102b (collectively, distributed processing nodes 102) via the communication line 111. The network switch 201 is a general LAN switch. The communication line 202 is included in the second communication line along with the communication line 111.

According to this configuration, while the execution node 110 and the processing nodes 101 and 102 are directly connected one to one in the configuration in FIG. 1, a relay connection is made via the network switch 201 in the present configuration. Accordingly, the processing nodes 101 and 102 are in a one to many connection by the foldback function of the network switch 201. Accordingly, the execution node 110 is capable of one to many connection by hardware processing, without performing software processing, thereby enabling low-latency interconnection among the aggregation processing nodes 101 and the distributed processing nodes 102.

Advantages of embodiments of the present invention will be described in further detail, focusing on operations of the overall system after a command to start learning has been given from the execution node 110 to the aggregation processing node 101. When a command to start learning is given from the execution node 110 to the aggregation processing node 101, preprocessing is first performed at the aggregation processing node 101. At this time, in the first embodiment, the preprocessing data is handed from the execution node 110 to the aggregation processing node 101, and further to the distributed processing nodes 102, by the SSH connection on the communication line 111 formed between the execution node 110 and the processing nodes 101 and 102. In this case, a load is placed on the execution node 110, and there are cases in which the communication bandwidth of the SSH is narrower than the physical speed of the LAN, and learning speed deterioration occurs.

Another advantage of the present configuration is that using a multi-port switch for the network switch 201 enables the number of ports to be increased, and even in a case of the number of processing nodes increasing, the distributed deep learning system 200 can be easily extended without changing the configuration equipment. Note that as for the capacity of the network switch 201, using a general nonblocking switch having a sufficient communication bandwidth is sufficient.

In the present configuration, when foldback is performed by hardware via the network switch 201, the load of SSH protocol operations at the execution node 110 is reduced. Accordingly, high-speed handover of preprocessing data is enabled among the processing nodes 101 and 102, and a stable and broad communication bandwidth can be secured, which is advantageous in that learning speed does not readily deteriorate. Note that when going through the network switch 201, using a protocol such as MPI (Message Passing Interface) often used in distributed systems is sufficient. Accordingly, even in a case where there is an increase in distributed processing nodes 102, efficient communication can be implemented between the aggregation processing node 101 and the distributed processing nodes 102.

### Extension of Embodiments

Although the present invention has been described above with reference to embodiments, the present invention is not limited to the above embodiments. Various changes, understandable by one skilled in the art can be made to the configurations and details of the present invention, can be made within the scope of the present invention. Also, the embodiments can be optionally combined and carried out insofar as there is no contradiction.

### REFERENCE SIGNS LIST

100, 200 Distributed deep learning system

101, 101a, 101b Aggregation processing node

102, 102a, 102b Distributed processing node

103 Interconnect (first communication line)

110 Execution node

111 Communication line (second communication line)

201 Network switch

202 Communication line (second communication line)

1,5 Microprocessor

2,6 Memory

3,7 Program

4A First communication circuit

4B Second communication circuit

8 Communication circuit

9 Console

1.-8. (canceled)

9. A distributed deep learning system comprising:
a plurality of distributed processing nodes configured to perform deep learning of a neural network, the distributed processing nodes distributed from each other; and
a plurality of aggregation processing nodes connected to the distributed processing nodes via a ring form communication line, the aggregation processing nodes configured to perform aggregation of distributed processing results obtained at the distributed processing nodes via the ring form communication line; and
an execution node connected to the aggregation processing nodes and the distributed processing nodes via a tree form communication line, the execution node configured to command execution of the aggregation processing nodes, wherein a communication bandwidth of the tree form communication line is greater than a communication bandwidth of the ring form communication line.

10. The distributed deep learning system of claim 9, wherein a quantity of the aggregation processing nodes is no greater than a quantity of the distributed processing nodes.

11. A distributed deep learning system comprising:
an M count (where M is an integer of 2 or greater) of distributed processing nodes configured to perform deep learning of a neural network distributed from each other; and
an N count (where N is an integer no greater than M) of aggregation processing nodes connected to each of the distributed processing nodes via a first communication line and a second communication line, the aggregation processing nodes configured to perform aggregation of distributed processing results obtained at the distributed processing nodes via the first communication line.

12. The distributed deep learning system of claim 11, wherein the second communication line has a tree structure with regard to the distributed processing nodes and the aggregation processing nodes.

13. The distributed deep learning system of claim 11, wherein the second communication line has a tree structure with regard to the distributed processing nodes and the aggregation processing nodes, via a network switch.

14. The distributed deep learning system of claim 11 further comprising:
an execution node connected to the second communication line, the execution node configured to command execution of the aggregation processing nodes.

15. The distributed deep learning system of claim 11, wherein, at the time of execution of the deep learning, minibatch data extracted from sample data used in the deep learning is distributed to the aggregation processing nodes via the second communication line.

16. The distributed deep learning system of claim 11, wherein, at the time of execution of the deep learning, initial values of gradient data relating to a learning model used in the deep learning and parameters for identifying the learning model are distributed to the aggregation processing nodes via the second communication line.

17. The distributed deep learning system of claim 11, wherein, in a case in which, out of the second communication line, a communication bandwidth of a path connected to the aggregation processing nodes is Beg and a communication bandwidth of a path connected to the distributed processing nodes is Bed, Beg and Bed are in a relation of Beg>Bed.

18. The distributed deep learning system of claim 11, wherein, in a case in which a communication bandwidth of the first communication line is Bi, and a communication bandwidth of the second communication line is Be, Bi and Be are in a relation of Be>Bi×0.01.

19. A distributed deep learning method comprising:
performing deep learning of a neural network at an M count (where M is an integer of 2 or greater) of distributed processing nodes, the distributed processing nodes distributed from each other; and
performing aggregation of distributed processing results at an N count (where N is an integer no greater than M) of aggregation processing nodes, the aggregation processing nodes connected to each of the distributed processing nodes via a first communication line and a second communication line, the distributed processing results obtained at the distributed processing nodes via the first communication line.

20. The distributed deep learning method of claim 19, wherein the second communication line has a tree structure with regard to the distributed processing nodes and the aggregation processing nodes.

21. The distributed deep learning method of claim 19, wherein the second communication line has a tree structure with regard to the distributed processing nodes and the aggregation processing nodes, via a network switch.

22. The distributed deep learning method of claim 19 further comprising:
commanding execution of the aggregation processing nodes at an execution node, the execution node connected to the second communication line.

23. The distributed deep learning method of claim 19, wherein, at the time of execution of the deep learning, minibatch data extracted from sample data used in the deep learning is distributed to the aggregation processing nodes via the second communication line.

24. The distributed deep learning method of claim 19, wherein, at the time of execution of the deep learning, initial values of gradient data relating to a learning model used in the deep learning and parameters for identifying the learning model are distributed to the aggregation processing nodes via the second communication line.

25. The distributed deep learning method of claim 19, wherein, in a case in which, out of the second communication line, a communication bandwidth of a path connected to the aggregation processing nodes is Beg and a communication bandwidth of a path connected to the distributed processing nodes is Bed, Beg and Bed are in a relation of Beg>Bed.

26. The distributed deep learning method of claim 19, wherein, in a case in which a communication bandwidth of the first communication line is Bi, and a communication bandwidth of the second communication line is Be, Bi and Be are in a relation of Be>Bi×0.01.
